(19) United States
(12) Patent Application Publication
(10) Pub. No.: US 2010/0001853 A1
(43) Pub. Date: Jan. 7, 2010

(54) VEHICLE LAMP CONTROL ARCHITECTURE

(75) Inventors: CHIU-SAN LEE, TAIPEI CITY (TW); YI-HSUN LEE, TAIPEI CITY (TW)

Correspondence Address: Muncy, Geissler, Olds & Lowe, PLLC, P.O. BOX 1364, FAIRFAX, VA, 22038-1364, US

(73) Assignee: XYZ SCIENCE CO., LTD.

(21) Appl. No.: 12/166,838

(22) Filed: Jul. 2, 2008

(51) Int. Cl. B60Q 1/26

(52) U.S. Cl. 340/468

(57) ABSTRACT

A vehicle lamp control architecture for solving the drawbacks of complicated circuit layout in the prior art includes a control base and a steering lever pivotally connected to the control base and having a first direction pivoting stroke and a second direction pivoting stroke, wherein the steering lever has a conducting element mounted thereon and the control base has two switch segments connected to the warning lamps and a power source and a balance segment connected with the two switch segments and a first status switch. In the normal state, the conducting element contacts with the balance segment for conducting the first status switch so as to drive the warning lamps to display a first indicting state, and the conducting element respectively contacts with the two switch segments in the first and the second direction pivoting strokes for driving the warning lamps to display a second indicating state.

### FIELD OF THE INVENTION

The present invention is related to a vehicle lamp control architecture, and more particularly to a vehicle lamp control architecture for dividing the failure indication and the direction indication of two sides warning lamps.

### BACKGROUND OF THE INVENTION

For general motorcycles and motor vehicles, the same set of warning lamps are used for indicating turn, fail and pass, and always, the indications of fail and pass are given the priority. Therefore, when the driver turns on the warning lamps for indicating failure or passing and still needs to change lane at the same time, the common setting will be the both sides of waning lamps remain the flash state for indicating failure and passing, and the right or the left side warning lamp can not individually flash for indicating the turning, so that the rear car can not recognize the moving tendency thereof, and thus, traffic accident might happen.

In view of this situation, the applicant provided an improvement, as disclosed in TWP No. 477309, entitled “Device for dividing warning lamps in turning, failure and passing”. Please refer to FIG. 1 which shows the circuit diagram thereof. The device is constituted by a control switch assembly, a pushing base, a steering lever, a fail and pass warning lamp switch 1, a second press switch 2, and press switches 3a, 3b, it is characterized in that the one of the loops from the positive and the negative electrodes of a battery 4 to the fail and pass warning lamp switch 1 has the second press switch 2. In the normal condition, the pushing base, which is located at one side of the vehicle control switch assembly and connected to the steering lever for controlling a set of bulbs 5 of the direction indicator, constantly presses the second press switch 2 for maintaining the conduction to the power source, and the fail and pass warning lamp switch 1 remains workable. Then, when the fail and pass warning lamp switch 1 is pressed, the set of bulbs 5, which is commonly used as the right side and the left side direction indicators and the fail and pass warning lights, are turned on. At this time, if the steering lever is pushed to make the pushing base to leave the second press switch 2 for disconnecting the loop of the fail and pass warning lamp and to let the pushing base to individually press one of the press switches 3a, 3b for conducting one of the bulbs 5 to light, then the right side or the left side direction indicator can be turned on.

However, in this disclosure, since the second press switch 2 and the press switches 3a, 3b which respectively control the fail and pass warning lamps and the direction indicator are separately mounted on the control switch assembly, for forming the loop, as shown in FIG. 1, the connecting terminals of different switches for connecting with the positive/negative electrodes of the battery 4 have to be set separately, which means the circuit layout is too complicated, in which there are at least 11 lines W1˜W11, the connecting terminals are up to 22 and there also have too many switch elements. Therefore, not only the assembling and installation are inconvenient, the wiring cost is also high.

### SUMMARY OF THE INVENTION

The object of the present invention is to solve the drawbacks described above so as to provide simplified circuit layout and less complicated structure.

For achieving the object described above, the present invention provides a vehicle lamp control architecture including a control base and a steering lever pivotally connected to the control base and having a first direction pivoting stroke and a second direction pivoting stroke, wherein the steering lever has a conducting element mounted thereon and the control base has two switch segments connected to the warning lamps and the power source and a balance segment connected with the two switch segments and the first status switch. In the normal state, the conducting element contacts with the balance segment for conducting the first status switch so as to drive the warning lamps to display the first indicting state, and the conducting element respectively contacts with the two switch segments in the first and the second direction pivoting strokes for driving the warning lamps to display the second indicating state. Therefore, the present invention utilizes the conducting element to pivotally switch between the contacts with the balance segment and the two switch segments for conducting the warning lamps, thereby simplifying the complexity of circuit layout.

Consequently, as compared with prior art, the present invention can achieve the efficiency of saving assembling time and wiring cost.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows the circuit layout of TWP No. 477309;

FIG. 2 is a schematic view showing the arrangement of the present invention;

FIG. 3 is a decomposition drawing showing the present invention;

FIG. 4 is a sectional view showing the conducting base of the present invention;

FIGS. 5A˜5B are schematic views showing the first operation state of the present invention;

FIGS. 6A˜6B are schematic views showing the second operation state of the present invention;

FIGS. 7A˜7B are schematic views showing the third operation state of the present invention;

FIG. 8 is a schematic view showing a first embodiment of the present invention;

FIG. 9 is a schematic view showing a second embodiment of the present invention; and

FIG. 10 is a schematic view showing a third embodiment of the present invention.

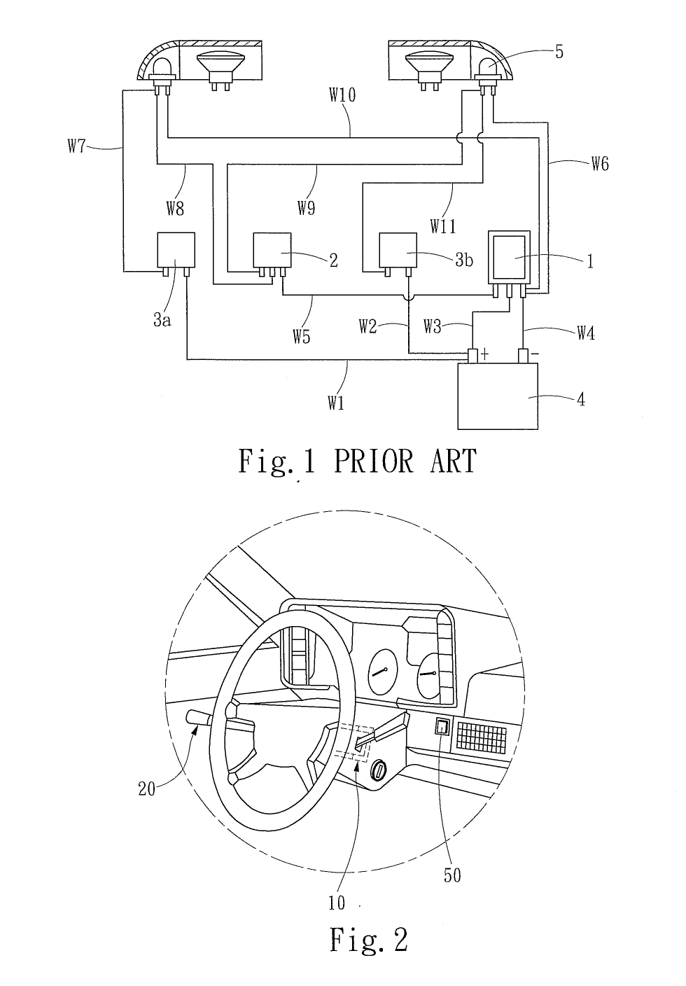

### DESCRIPTION OF THE PREFERRED EMBODIMENT

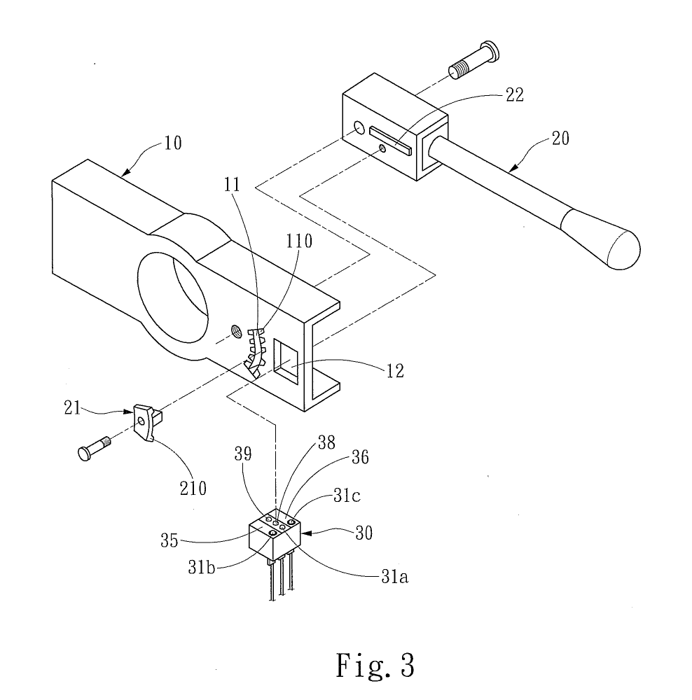

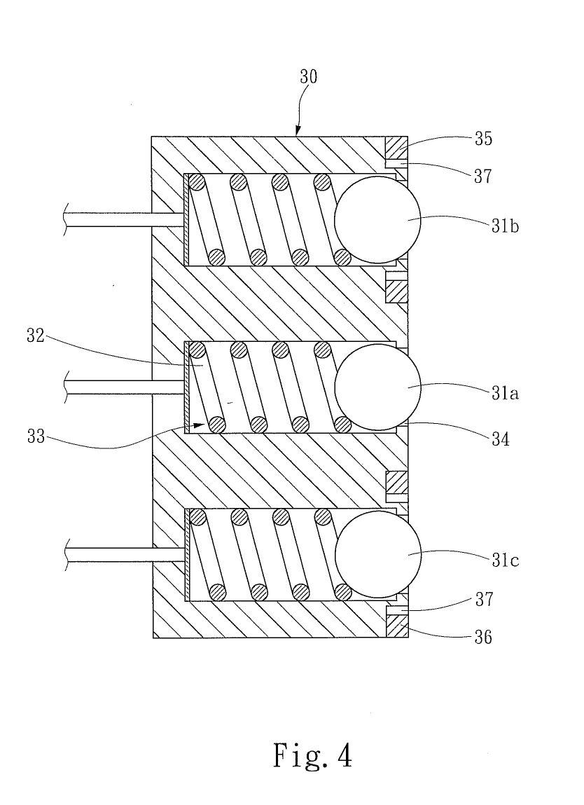

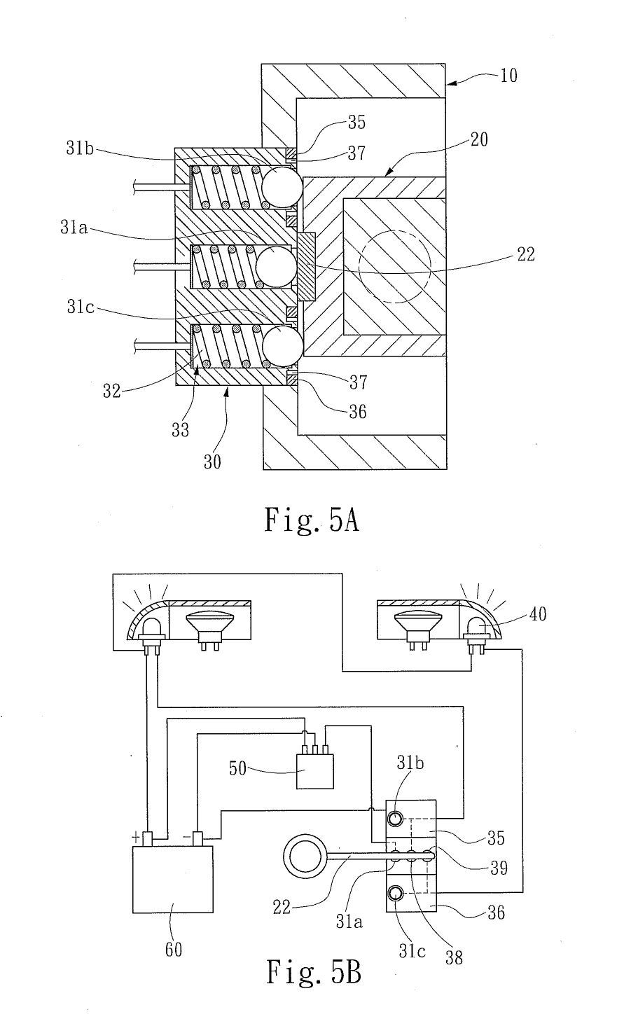

Please refer to FIG. 2, FIG. 3, FIG. 4 and FIG. 5B. The present invention is related to a vehicle lamp control architecture suitable for motor vehicle, motorcycle or bicycle. Take motor vehicle as an example. The vehicle lamp control architecture includes a control base 10 and a steering lever 20 (or a switch button used in the motorcycles or bicycles), wherein the steering lever 20 is pivotally connected to the control base 10 and has a first direction pivoting stroke and a second direction pivoting stroke (such as clockwise direction and counterclockwise direction) relative to the control base 10, and the control base 10 has a positioning hole 1I1 for passing through a positioning element 21 of the steering lever 20, in which the positioning hole 11 and the positioning element 21 respectively have a positioning indentation 110 and a positioning protrusion 210 for correspondingly matching to each other so as to achieve a position-limiting relationship in the pivoting strokes of the steering lever 20. It should be noticed that the steering lever 20 has a conducting element 22 and the control base 10 has a balance segment and two switch segments, as shown in FIG. 5B, wherein each switch segment includes an electric connecting element 35, 36 for connecting to a power source 60 and is respectively connected to conductors 31b, 31c of two sides warning lamps 40. In the present invention, the electric connecting element 35 is directly connected to the power source 60 and the electric connecting element 36 is connected to the electric connecting element 35 for indirectly obtaining the power, and an insulation portion 37 (such as trench) is mounted between the electric connecting elements 35, 36 and the conductors 31b, 31c. Moreover, the control architecture further includes a first status switch 50 connected to the power source 60, and the balance segment includes a conductor 31a for connecting to the first status switch 50 and two relay bodies 38, 39 for respectively connecting to the conductors 31b, 31c. In the shown embodiment, the conductors 31a, 31b, 31c and the relay bodies 38, 39 are metal spheres mounted in accommodating spaces 33 in the conducting base 30, which is installed in an assembling opening 12 of the control base 10, and the accommodating spaces 33 respectively have a position-limiting opening 34 at the outer edge thereof and an elastic element 32 (such as spring) therein for supporting the conductors 31a, 31b, 31c and the relay bodies 38, 39.

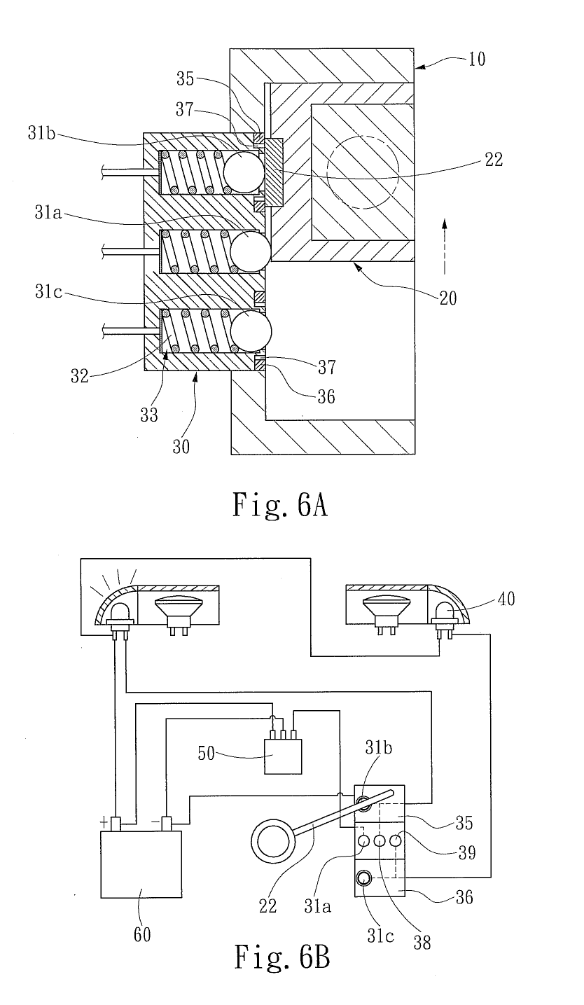

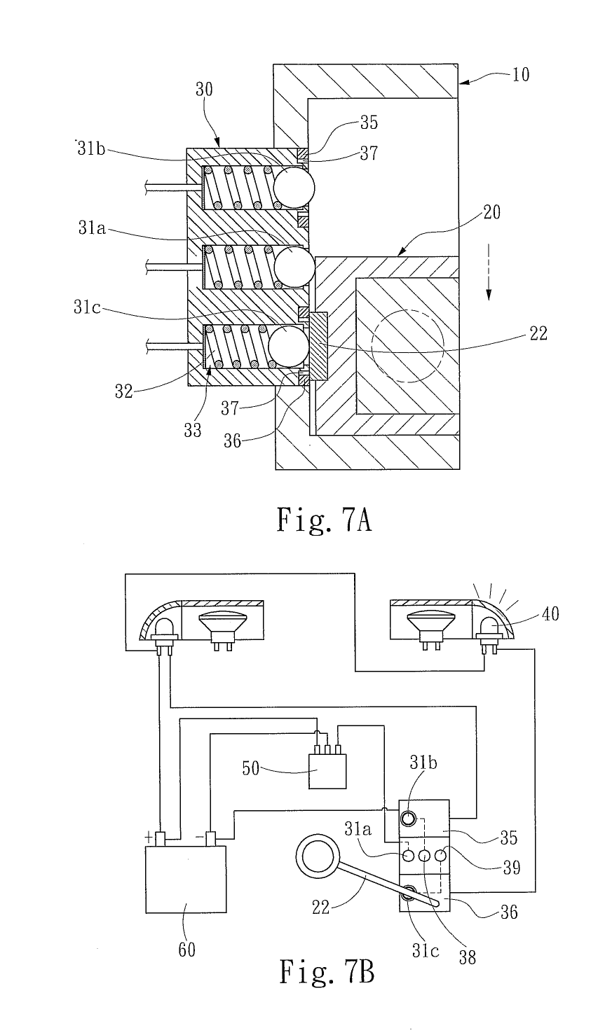

As shown in FIG. 5A and FIG. 5B, in the normal condition, the conducting element 22 contacts the conductor 31 a and the two relay bodies 38, 39 of the balance segment. When the first status switch 50 is not pressed, the two sides warning lamps are off, and when the vehicle is stopped at the roadside or has failure and the first status switch 50 is activated, the power is transmitted from the positive electrode of the power source 60 to the two sides warning lamps 40, then passes through the conductors 31b, 31c, the relay bodies 38, 39, the conducting element 22 and the conductor 31a, and goes back to the negative electrode of the power source 60 from the first status switch 50, so as to form a loop which simultaneously conducts the two sides warning lamps 40 to display a first indicating state. At this time, if the driver needs to change the lane, namely, the driver pushes the steering lever 20 to have the first direction pivoting stroke (as shown in FIG. 6A) without turning off the first status switch 50, the conducting element 22 will depart from the conductor 31a and the relay bodies 38, 39 of the balance segment to turn off the first indicating state and then connect to the conductor 31b, so that the power of the power source 60 will output from the positive electrode to the left side warning lamp 40, pass through the conductor 31b, the conducting element 22 and the electric connecting element 35, and go back to the negative electrode of the power source 60, so as to form a loop which conducts the left side warning lamp 40 to display a second indicating state (as shown in FIG. 6B). Moreover, if the driver pushes the steering lever 20 to have the second direction pivoting stroke (as shown in FIG. 7A), the conducting element 22 will depart from the conductor 31a and the relay bodies 38, 39 of the balance segment to turn off the first indicating state and then connect to the conductor 31c, so that the power of the power source 60 will output from the positive electrode to the right side warning lamp 40, pass through the conductor 31c, the conducting element 22 and the electric connecting element 36, and go back to the negative electrode of the power source 60, so as to form a loop which conducts the right side warning lamp 40 to display a second indicating state (as shown in FIG. 7B). Therefore, even the driver directly pushes the steering lever 20 without turning off the first status switch 50, the conducting element 22 can have a corresponding response to the position change of the steering lever 20 for switching the warning lamp 40 from the first indicating state to the second indicating state, and thus, the rear car can notice the indicating state of the warning lamp 40 and realize the moving tendency thereof.

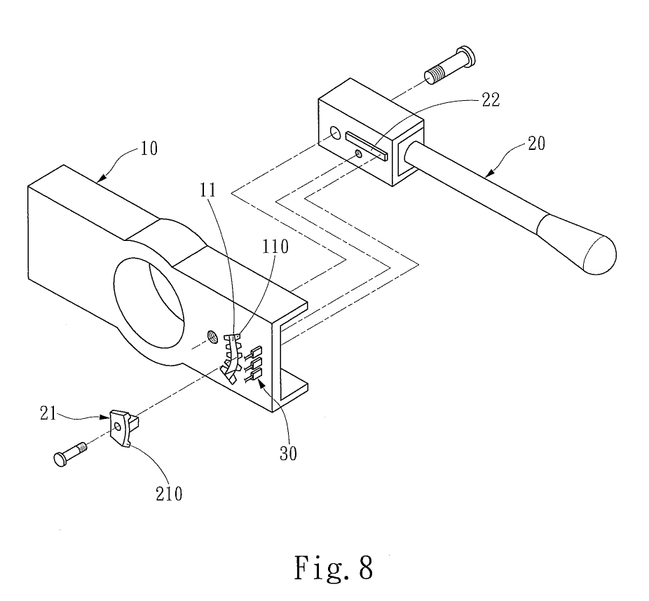

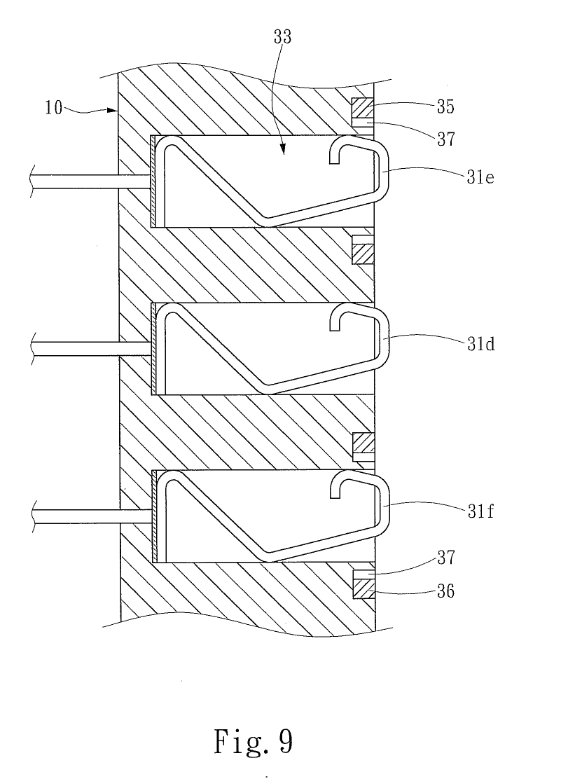

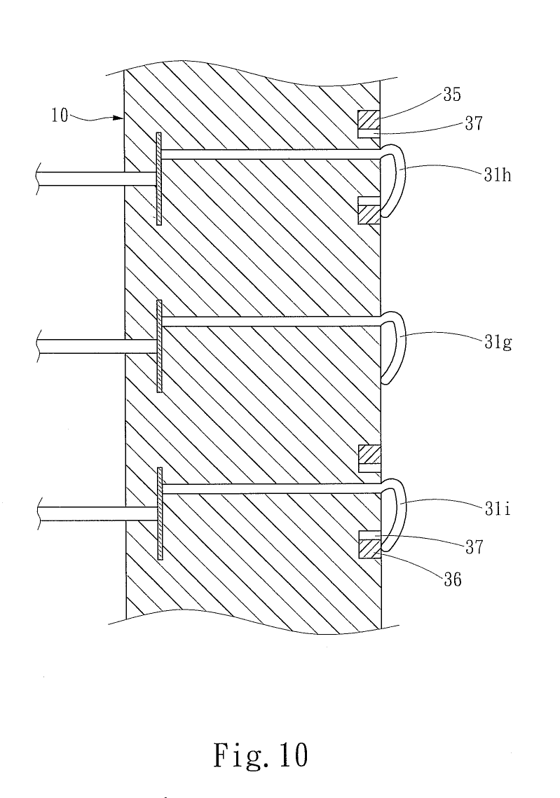

Furthermore, in the present invention, except forming the assembly opening 12 on the control base 10 for installing the conducting base 30, they also can be formed to be an integral control base 10, as shown in FIG. 8, and further, the conductors 31d, 31e, 31f can be clips (as shown in FIG. 9), so that, through the elasticity thereof, they can reject to the conducting element 22 to form the loop when the steering lever 20 is pivoted. Besides, as shown in FIG. 10, the conductors 31g, 31h, 31i also can be conducting pieces penetrating the control base 10 which are formed by embedding in the integrally formed control base 10 as shaping the control base 10.

In the aforesaid, the present invention utilizes the conducting element 22 to the balance segment and the two switch segments simultaneously mounted on the conducting base 30 as the steering lever 20 is pivoted, so as to conduct the warning lamp 40, such that not only the rear car can clearly realize the moving tendency so as to achieve driving safety, but the effective and simple circuit layout which cuts out to at least 8 lines also reduce the assembling time and the wiring cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vehicle lamp control architecture, comprising a control base and a steering lever pivotally connected to the control base and having a first direction pivoting stroke and a second direction pivoting stroke, wherein the steering lever is conducted to a first status switch, which is connected to a power source, for driving a first indicating state of warning lamps of a vehicle and driving a second indicating state of the warning lamps in the first and the second direction pivoting strokes, comprising:
the steering lever has a conducting element mounted thereon and the control base has two switch segments connected to the warning lamps and the power source and a balance segment connected with the two switch segments and the first status switch, wherein the conducting element contacts with the balance segment for conducting the first status switch so as to drive the warning lamps to display the first indicting state, and the conducting element respectively contacts with the two switch segments in the first and the second direction pivoting strokes for driving the warning lamps to display the second indicating state.

2. The vehicle control architecture as claimed in claim 1, wherein each switch segment comprises a conductor connected to the warning lamps and an electric connecting element connected to the power source, and the conducting element contacts with the electric connecting element and the conductor for conducting power and driving the warning lamps to display the second indicating state.

3. The vehicle control architecture as claimed in claim 2, wherein each switch segment has an insulation portion mounted between the electric connecting element and the conductor.

4. The vehicle control architecture as claimed in claim 3, wherein the insulation portion is a trench.

5. The vehicle control architecture as claimed in claim 2, wherein the balance segment comprises a conductor electrically connected to the first status switch and two relay bodies respectively connected to the conductors of the two switch segments, and the conducting element contacts with the conductor and the relay bodies of the balance segment for conducting the power to the conductors of the two switch segments so as to drive the warning lamps to display the first indicating state.

6. The vehicle control architecture as claimed in claim 5, wherein the control base has a conducting base for mounting the conductors and the relay bodies.

7. The vehicle control architecture as claimed in claim 6, wherein the conducting base has accommodating spaces and position-limiting openings respectively mounted at the outer edges of the accommodating spaces, so that the conductors and the relay bodies are accommodated in the accommodating spaces and limited by the position-limiting openings, and the conducting base also has elastic elements mounted in the accommodating spaces for supporting the conductors and the relay bodies.

8. The vehicle control architecture as claimed in claim 7, wherein the conductors and the relay bodies are metal spheres.

9. The vehicle control architecture as claimed in claim 6, wherein the conductors are clips.

10. The vehicle control architecture as claimed in claim 5, wherein the conductors penetrate through the conducting pieces of the control base.
